(19) United States
(12) Patent Application Publication
(10) Pub. No.: US 2013/0058615 A1
(43) Pub. Date: Mar. 7, 2013

(54) Cable Carrier Device

(71) Applicants: Ajilivelil Thomas MATHEW, Kochi (IN); Kizhakkekuttu Parameswaran Chandran, Kochi (IN); Biji Mathew Arakkakudy, Kochi (IN); Sudhakaran K. Sanith, Kochi (IN); K.R. Suresh Nair, Kochi (IN)

(72) Inventors: Ajilivelil Thomas MATHEW, Kochi (IN); Kizhakkekuttu Parameswaran Chandran, Kochi (IN); Biji Mathew Arakkakudy, Kochi (IN); Sudhakaran K. Sanith, Kochi (IN); K.R. Suresh Nair, Kochi (IN)

(73) Assignee: Opterna AM, Inc., Sterling, VA (US)

(21) Appl. No.: 13/224,983

(22) Filed: Sep. 2, 2011

(51) Int. Cl. G02B 6/46; B23P 11/00

(52) U.S. Cl. 385/135; 29/428

(57) ABSTRACT

A carrier device for advancing a fiber optic cable having a connector on one end of the fiber optic cable through a conduit includes a first carrier member and a second carrier member configured to be selectively coupled to the first carrier member. The first carrier member defines a first hollow portion with a first width and a second hollow portion with a second width. The first hollow portion is configured to receive a first portion of a connector on one end of a fiber optic cable. A connector seated in the first hollow portion is securely coupled to the carrier device.

### BACKGROUND

1. Field

The present invention relates to a carrier device for use with a cable and, particularly, a carrier device for use with a fiber optic cable having a connector.

2. Background Art

Typically, during fiber optic cable installation, a fiber optic cable travels from one point to another. For example, in a multi-unit building installation, fiber optic cables may travel from a fiber optic collector plate on the first floor of a building to a fiber distribution terminal on a higher floor of the building. For protection and organization of fiber optic cables along such lines of travel, the fiber optic cables are generally run through a protective conduit.

A fiber optic cable may include a connector at one end of the cable to optically couple the fibers of the fiber optic cable to another cable, device, or light source. Generally, during installation, a cord (e.g., a nylon string or cable) is advanced through a conduit, and attached to the connector. Connectors often have a width greater than the diameter of the cable portion of the fiber optic cable, and have sharp angles at their edges. Consequently, connectors often snag on other fiber optic cables and objects within the conduit, making installation difficult.

Accordingly, there is a need for carrier devices that are used to snake fiber optic cables through conduits during installation, and for methods of using carrier devices with fiber optic cables having connectors.

### BRIEF SUMMARY

In one embodiment, a carrier device for advancing a fiber optic cable having a connector on one end of the fiber optic cable through a conduit includes a first carrier member defining a first hollow portion with a first width and a second hollow portion with a second width. The first hollow portion is configured to receive a first portion of a connector on one end of a fiber optic cable. The carrier device also includes a second carrier member configured to be selectively coupled to the first carrier member such that a connector seated in the first hollow portion is securely coupled to the carrier device. The second width is smaller than the first width.

In another embodiment, a method of using a fiber optic cable having a connector on one end of the fiber optic cable includes inserting a first portion of the connector of the fiber optic cable into a first hollow portion defined by a first carrier member of a carrier device. The first hollow portion has a first width. A first portion of the fiber optic cable proximal to the connector is inserted in a second hollow portion defined by the first carrier member. The second hollow portion has a second width. The method also includes coupling the first carrier member to a second carrier member of the carrier device to securely couple the fiber optic cable to the carrier device.

### BRIEF DESCRIPTIONS OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a perspective view of a carrier device according to one embodiment.

FIG. 2 is a side perspective view of the carrier device of FIG. 1 and a fiber optic cable.

FIG. 3 is a side perspective view of the carrier device of FIGS. 1 and 2, and a fiber optic cable.

FIG. 4 is a process flowchart illustrating a method of using a fiber optic cable with the carrier device.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

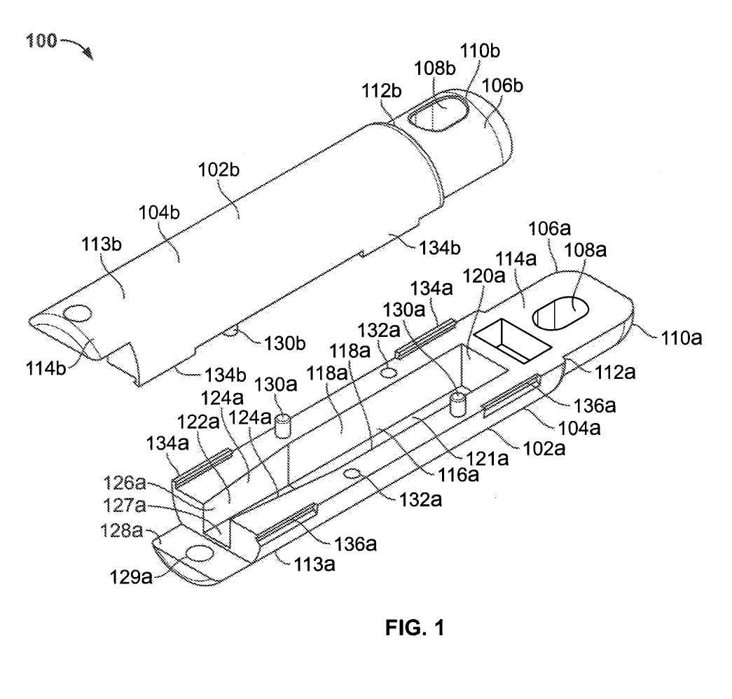

FIG. 1 is a perspective view of a carrier device 100. As shown in FIG. 1, carrier device 100 includes a first carrier member 102a and a second carrier member 102b. First carrier member 102a is selectively coupled to (i.e., joined with) second carrier member 102b to securely couple an end of a fiber optic cable to carrier device 100. After use, a user can uncouple first carrier member 102a from second carrier member 102b, releasing the fiber optic cable.

As shown in FIG. 1, first carrier member 102a includes a proximal portion 104a and a distal portion 106a. Distal portion 106a defines an eyelet 108a. Eyelet 108a is sized to receive a cord for pulling carrier device 100 through a conduit. Eyelet 108a extends completely through distal portion 106a. In another embodiment, instead of eyelet 108a, distal portion 106a has a hook shape for coupling with a loop in the cord.

Distal portion 106a has a rounded distal edge 110a. Rounded distal edge 110a prevents carrier device 100 from snagging on other cables or objects within the conduit as carrier device 100 is advanced (i.e., moved) through the conduit. In another embodiment, distal edge 110a is slanted.

As shown in FIG. 1, distal portion 106a is narrower than proximal portion 104a. Accordingly, a shoulder 112a is formed between proximal portion 104a and distal portion 106a. Shoulder 112a is rounded, as shown in FIG. 1, or slanted. The rounded or slanted contour of shoulder 112a prevents carrier device 100 from snagging other cables or objects within the conduit, similar to rounded distal edge 110a. In other embodiments, distal portion 106a and proximal portion 104a have the same outer width, that is, the outer width of carrier device 100 is constant.

First carrier member 102a has an outer surface 113a, which is exposed when coupled to second carrier member 102b, and an engagement surface 114a, which is not exposed and is adjacent second carrier member 102b when first carrier member 102a is coupled to second carrier member 102b. As shown in FIG. 1, engagement surface 114a is planar. In other embodiments, engagement surface 114a is non-planar.

Proximal portion 104a defines a distal hollow portion 116a. Distal hollow portion 116a is configured to receive a connector on one end of the fiber optic cable. Distal hollow portion 116a has a shape that corresponds to the shape of the connector. Distal hollow portion 116a is a recess in engagement surface 114a. As shown in FIG. 1, distal hollow portion 116a is substantially rectangular and is defined by a pair of opposing sidewalls 118a and distal wall 120a. Sidewalls 118a and distal wall 120a extend downward from engagement surface 114a to a floor 121a. The width of distal hollow portion 116a is constant along the entire the length of distal hollow portion 116a. In other embodiments, distal hollow portion 116a can have any other suitable shape, for example, square, oval, or circle.

Distal hollow portion 116a has a depth such that only a bottom portion of a connector of a fiber optic cable is inserted into distal hollow portion 116a, leaving an upper portion exposed. In one embodiment, distal hollow portion 116a has a depth such that the lower half of the connector fits within distal hollow portion 116a. In another embodiment, distal hollow portion 116a has a depth such that the entire connector of the fiber optic cable is inserted into distal hollow portion 116a.

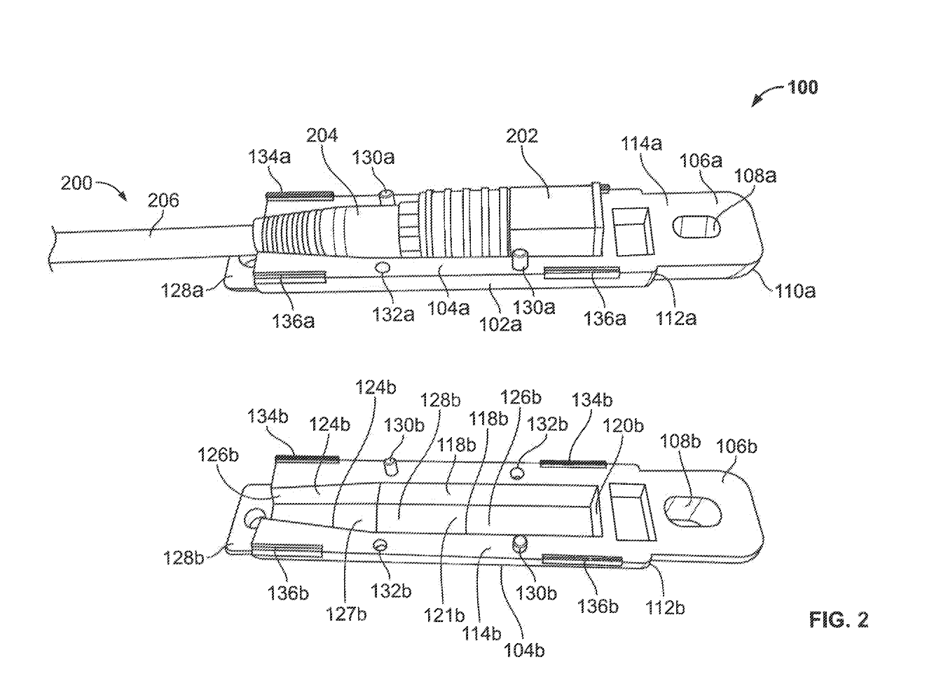

As shown in FIG. 1, proximal portion 104a also defines a proximal hollow portion 122a. Proximal hollow portion 122a is adjacent to distal hollow portion 116a. Proximal hollow portion 122a is configured to receive a portion of a fiber optic cable that is proximal to a connector of the fiber optic cable. Proximal hollow portion 122a has an opening 126a at a proximal end of first carrier member 102a. Proximal hollow portion 122a is defined by a pair of opposing walls 124a that extend downward from engagement surface 114a to a floor 127a. In one embodiment, walls 124a converge towards each other as they extend away from the distal end of first carrier member 102a towards opening 126a. In other words, the width of proximal hollow portion 122a decreases as proximal hollow portion 122a extends towards the proximal end of carrier member 102a. Opposing walls 124a are straight (as shown in FIGS. 1 and 2) or curved. Floor 127a of proximal hollow portion 122a is inclined relative to the floor 121a of distal hollow portion 116a. Accordingly, the depth of proximal hollow portion 122a decreases as proximal hollow portion 122a extends towards opening 126a. As shown in FIG. 1, one dimension (for example, width) of proximal hollow portion 122a is smaller than the corresponding dimension (for example, width) of distal hollow portion 116a.

Proximal hollow portion 122a has a depth such that only a bottom portion of a fiber optic cable proximal to a connector is inserted into proximal hollow portion 122a. In one embodiment, proximal hollow portion 122a has a depth such that the lower half of the portion of the fiber optic cable proximal to a connector fits within distal hollow portion 116a. In another embodiment, proximal hollow portion 122a has a depth such that the entire portion of the fiber optic cable proximal to the connector is inserted into proximal hollow portion 122a.

Carrier member 102a also includes a proximal tab 128a. Proximal tab 128a extends from the proximal end of carrier member 102a. Proximal tab 128a extends only from a radially outer portion of the proximal end of carrier member 102a. Proximal tab 128a defines an eyelet 129a that extends completely through proximal tab 128a.

First carrier member 102a includes one or more pins 130a extending from engagement surface 114a having any suitable cross section, for example, square or circular. As shown in FIG. 1, first carrier member 102a includes two circular pins 130a extending from engagement surface 114a. One pin 130a extends from an outer left side, proximal end of first carrier member 102a, and the other pin 130a extends from an outer right side, distal end of first carrier member 102a. In other embodiments, first carrier member 102a includes one pin 130a or more than two pins 130a or have different pin locations. Pins 130a are configured to be inserted in respective recesses 132b in second carrier member 102b.

First carrier member 102a has one or more recesses 132a for receiving respective one or more pins 130b of second carrier member 102b. As shown in FIG. 1, first carrier member 102a includes two recesses 132a in engagement surface 114a. The first recess 132a is on the outer left side, distal end of first carrier member 102a, and the other recess is an outer right side, proximal end of first carrier member 102a. Recesses 132a of first carrier member are configured to closely receive pins 130b of second carrier member 102b such that first carrier member 102a is selectively and securely coupled to second carrier member 102b through a snap or press fit.

First carrier member 102a includes one or more peripheral protrusions 134. As shown in FIG. 1, peripheral protrusions 134a extend upward from engagement surface 114a along its peripheral edge. In one embodiment, peripheral protrusions 134a are located along a peripheral edge on one side of first carrier member 102a. As shown in FIG. 1, first carrier member 102a includes two peripheral protrusions 134a extending from engagement surface 114a. Peripheral protrusion 134a is elongated and, in one embodiment, is rectangular.

First carrier member 102a includes one or more peripheral recesses 136a. As shown in FIG. 1, peripheral recesses 136a is located along a peripheral edge on one side of first carrier member 102a. Peripheral recesses 136a are located on the peripheral edge opposite from the peripheral edge having peripheral protrusions 134a. First carrier member 102a has two peripheral recesses 136a. Peripheral protrusion 134a is elongated and, in one embodiment, is rectangular.

Peripheral protrusions 134a of first carrier member 102a are inserted in respective peripheral recesses 136b of second carrier member 102b (as shown in FIG. 2). Peripheral recesses 136a of first carrier member 102a receive respective peripheral protrusions 134b of second carrier member 102b. Coupling peripheral recesses 136a and 130 with respective peripheral protrusion 134a and 134b of first and second carrier members 102a and 102b, prevents axial and transverse translation of first carrier members 102a and 102b relative to each other.

Second carrier member 102b can be substantially identical to first carrier member 102a as shown in FIGS. 1 and 2. Similar features of second carrier member 102b are indicated by using similar reference numbers, with the letter “b” appended in place of “a” to distinguish the features. First carrier member 102a can be hermaphroditic with regards to any combination of pins 130a, recesses 132a, peripheral protrusions 134a, and peripheral recesses 136a. In such an embodiment, only one carrier device 100 needs to be manufactured to have first carrier member 102a and second carrier member 102b. Accordingly, manufacturing costs for making carrier device 100 are decreased. In other embodiments, second carrier member 102b can have any combination of the features in the various embodiments described above with reference to first carrier member 102a.

In another embodiment, second carrier member 102b is not substantially identical to first carrier member 102a. For example, when the depth of distal hollow portion 116a is deep enough such that the entire connector of a fiber optic cable fits within distal hollow portion 116a, second carrier member may not have a distal hollow portion 116b or a proximal hollow portion 122b—engagement surface 114b of second carrier member 102b may not have any recesses.

First and second carrier members 102a and 102b are made from any suitable material, for example, plastic, metal, or a composite.

FIG. 2 is a side perspective view of carrier device 100 and a fiber optic cable 200. Fiber optic cable 200 includes a connector 202, a crimping portion 204, and a cable portion 206. Connector 202 is on one end of fiber optic cable 200. Cable portion 206 includes one or more optic fibers surrounded by a protective jacket. Cable portion 206 can include structural members that run the length of fiber optic cable 200 to strengthen cable portion 206, preventing damage to the optic fibers caused by forces applied to the fibers within cable portion 206. For example, structural members can include metal rods or a Kevlar jacket surrounding the fibers in cable portion 206. Crimping portion 204 couples cable portion 206 to connector 202. In one embodiment, crimping portion 204 secures the structural members of cable portion 206 to the distal end of cable portion 206. In some embodiments, crimping portion 204 has a tapered outer surface, that is, crimping portion 204 has an outer diameter that decreases as crimping portion 204 extends away from connector 202.

As shown in FIG. 2, connector 202 is inserted into distal hollow portion 116a of first carrier member 102a. The rectangular shape of distal hollow portion 116a corresponds to the rectangular shape of connector 202. As shown in FIG. 2, distal hollow portion 116a has a depth such that only a lower portion of connector 202 is within distal hollow portion 116a. The upper portion of connector 202 extends above engagement surfaces 114a and 114b.

When connector 202 is inserted in distal hollow portion 116a, crimping portion 204 and/or a length of cable portion 206 are received in proximal hollow portion 122a, and cable portion 206 extends through opening 126a. If crimping portion 204 has a tapered outer contour, as carrier device 100 is moved in one direction (for example, during advancement through a conduit), the tapered outer surface of crimping portion 204 will move in a direction opposite to the movement of carrier device 100 due to the weight of the cable 200, contacting the tapered walls 124a defining proximal hollow portion 122a. In other words, when carrier device 100 is advanced through a conduit, carrier device 100 applies a force to a portion of fiber optic cable 200 that is proximal to connector 202, for example, crimping portion 204 or cable portion 206. Applying a force proximal to connector 202, and not on connector 202 itself, protects connector 202 from the forces that would be applied while installing fiber optic cable 200.

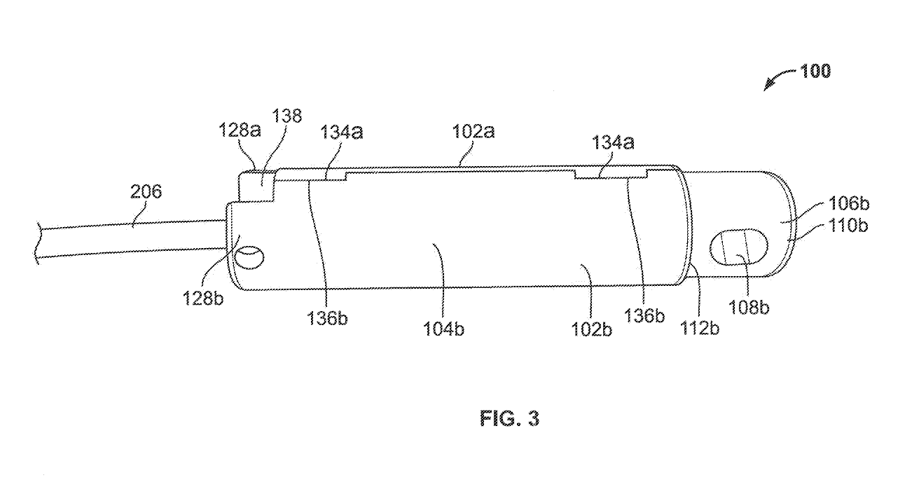

FIG. 3 is a side perspective view of device 100 securely coupled to fiber optic cable 200. As shown in FIG. 3, first carrier member 102a selectively and securely couples to second carrier member 102b, which in turn securely couples carrier device 100 to fiber optic cable 200. Carrier member 102a and carrier member 102b completely enclose connector 202 and crimping portion 204 of fiber optic cable 200 when coupled together. Accordingly, carrier device 100 prevents connector 202 from snagging other cables or objects in the conduit during installation.

To couple first carrier member 102a to second carrier member 102b, pins 130a of first carrier member 102a are inserted into respective recesses 132b of second carrier member 102b. Pins 130b of second carrier member 102b are inserted into respective recesses 132a of first carrier member 102a. Peripheral protrusions 134a of first carrier member 102a are inserted into peripheral recesses 136b of second carrier member 102b. Peripheral protrusions 134b of second carrier member 102b are inserted into peripheral recesses 136a of the first carrier member 102a.

In embodiments having eyelets 108a and 108b defined in distal portions 106a and 106b of first and second carrier members 102a and 102b, when first carrier member 102a is coupled to second carrier member 102b, eyelets 108a and 108b are aligned creating one continuous eyelet through both first and second carrier members 102a and 102b. A cord is attached to carrier device 100 through aligned eyelets 108a and 108b.

Proximal tabs 128a and 128b extending from outer portions of the proximal end of carrier device 100 define an internal recess 138. Internal recess 138 can be used as a location to insert a user's finger to separate first carrier member 102a and second carrier member 102b, for example, after fiber optic cable 200 has been advanced through the conduit.

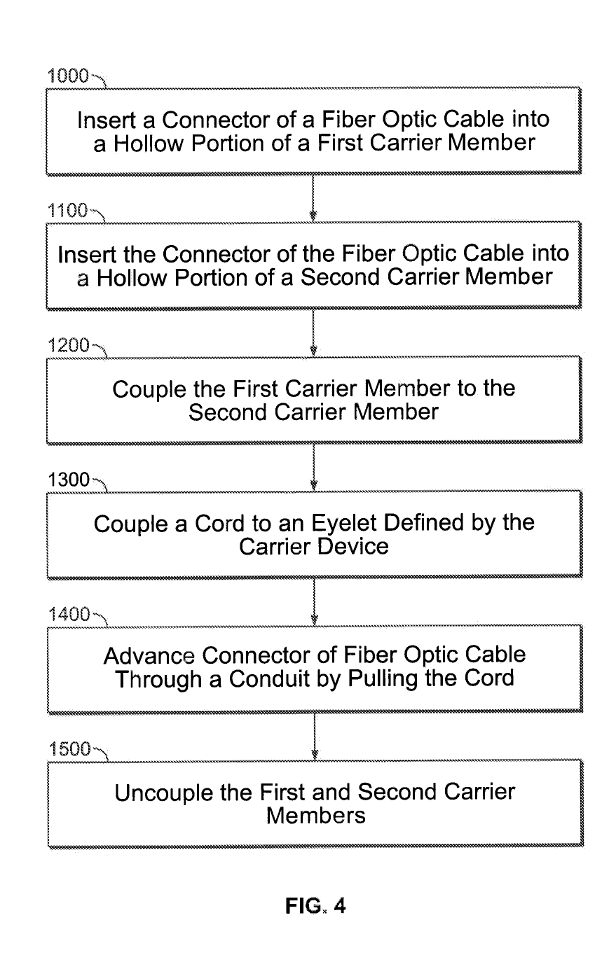

FIG. 4 is a process flowchart illustrating a method of using carrier device 100 with fiber optic cable 200. The method includes inserting a connector 202 of fiber optic cable 200 into distal hollow portion 116a of first carrier member 102a at step 1000. In one embodiment, at step 1100, the method also includes inserting connector 202 into distal hollow portion 116b of second carrier member 102a. Step 1100 can be eliminated, for example, in embodiments in which distal hollow portion 116a of first carrier member 102 is deep enough such that the entire connector 202 fits within distal hollow portion 116a, thus second carrier member 102b may not have distal hollow portion 116b.

At step 1200, first carrier member 102a is coupled to second carrier member 102b to secure connector 202 and fiber optic cable 200 to carrier device 100. Coupling first carrier member 102a to second carrier member 102b includes inserting one or more pins 130a and 130b into one or more respective recesses 132a and 132b. Coupling first carrier member 102a to second carrier member 102b includes inserting one or more peripheral protrusions 134a and 134b into one or more respective peripheral recesses 136a and 136b.

The method of using the fiber optic cable also includes, at step 1300, coupling a cord to the carrier device 100. For example, the cord can be attached to aligned eyelets 108a and 108b of first and second carrier members 102a and 102b. In one embodiment, the cord has been already advanced through the conduit before it is attached to carrier device 100. In another embodiment, the cord is first coupled to carrier device 100 and then advanced through the conduit.

The end of the cord not coupled to carrier device 100 is then pulled to advance carrier device 100 through the conduit at step 1400, advancing fiber optic cable 200 through the conduit. While carrier device 100 is being advanced through the conduit, a force is applied to a proximal side of connector 202 of fiber optic cable 200, for example, on crimping portion 204 or cable portion 206. Applying force to a proximal side of connector 202 helps prevent any damage to connector 202. Additionally, because carrier device 100 completely encloses connector 202, carrier device 100 prevents connector 202 from contacting any other cables or objects within the conduit, which prevents snagging.

At step 1500, once carrier device 100 with connector 202 is advanced all the way through the conduit to a target location, first carrier member 102a is uncoupled from second carrier member 102b, and connector 202 is removed from distal hollow portion 116a. Connector 202 is then coupled to another fiber optic cable, device, or light source. In one embodiment, carrier device 100, including first carrier member 102a and second carrier member 102b, is disposed of or thrown away after step 1500.

In another embodiment, coupling the first carrier member 102a to second carrier member 102b (step 1200) occurs before shipping fiber optic cable 200 to a customer, for example, a fiber optic cable installer. In such an embodiment, carrier device 100 protects connector 202 of fiber optic cable 200 from damage while being shipped to the customer.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. For example, although the above description includes fiber optic cable 200, carrier device 100 can be adapted for use with other cables, for example, electrical wires and cords. Therefore, such adaptations and modifications are intended to be within the meaning and range of equivalents of the disclosed embodiments, based on the teaching and guidance presented herein.

It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. A carrier device for advancing a fiber optic cable having a connector on one end of the fiber optic cable through a conduit, comprising:
a first carrier member defining a first hollow portion with a first width and a second hollow portion with a second width, the first hollow portion being configured to receive a first portion of a connector on one end of a fiber optic cable; and
a second carrier member configured to be selectively coupled to the first carrier member such that a connector seated in the first hollow portion is securely coupled to the carrier device.

2. The carrier device of claim 1, wherein the second carrier member defines a third hollow portion with a third width and a fourth hollow portion with a fourth width, the third hollow portion being configured to receive a second portion of a connector on one end of a fiber optic cable.

3. The carrier device of claim 2, wherein the fourth width is smaller than the third width.

4. The carrier device of claim 1, wherein the first carrier member has a first eyelet.

5. The carrier device of claim 1, wherein the second width is smaller than the first width.

6. The carrier device of claim 1, wherein the first carrier member and the second carrier member are substantially identical.

7. The carrier device of claim 1, wherein the second width of the second hollow portion decreases as the second hollow portion extends towards a proximal end of the carrier device.

8. The carrier device of claim 7, wherein the second hollow portion is configured to contact a fiber optic cable on a proximal side of a connector.

9. The carrier device of claim 8, wherein the second hollow portion is configured to contact a tapered portion of a fiber optic cable.

10. The carrier device of claim 1, wherein the first carrier member has a tapered distal edge.

11. The carrier device of claim 1, wherein the first carrier member has a semi-circular outer contour.

12. The carrier device of claim 1, wherein the first carrier member has a pin extending from a surface, and wherein the second carrier member has a recess configured to receive the pin of the first carrier member to selectively couple the first carrier member to the second carrier member.

13. The carrier device of claim 1, wherein the first carrier member further comprises a first tab portion that extends from a proximal end of the first carrier member, wherein the second carrier member further comprises a second tab portion that extends from a proximal end of the second carrier member, and wherein the first tab portion and the second tab portion define an interior recess.

14. A method of using a fiber optic cable having a connector on one end of the fiber optic cable, the method comprising:
inserting a first portion of the connector of the fiber optic cable into a first hollow portion defined by a first carrier member of a carrier device, the first hollow portion having a first width, wherein a first portion of the fiber optic cable proximal to the connector is inserted in a second hollow portion defined by the first carrier member, the second hollow portion having a second width; and
coupling the first carrier member to a second carrier member of the carrier device to securely couple the fiber optic cable to the carrier device.

15. The method of claim 14 further comprising inserting a second portion of the connector of the fiber optic cable into a third hollow portion defined by the second carrier member of the carrier device, the third hollow portion having a third width, wherein a second portion of the fiber optic cable proximal to the connector is inserted in a fourth hollow portion defined by the second carrier member, the fourth hollow portion having a fourth width.

16. The method of claim 14, wherein the second width is smaller than the first width.

17. The method of claim 14 further comprising:
coupling a cord to an eyelet defined by the carrier device; and
advancing the fiber optic cable through a conduit by pulling the cord through the conduit.

18. The method of claim 17, wherein advancing the fiber optic cable through the conduit comprises applying a force to a proximal side of the connector.

19. The method of claim 18, wherein applying the force to the proximal side of the connector comprises applying the force to a tapered portion of the fiber optic cable.

20. The method of claim 17 further comprising uncoupling the first and second carrier members after advancing the fiber optic cable through the conduit.

21. The method of claim 17, wherein coupling the first carrier member to the second carrier member occurs before shipping the fiber optic cable to a customer.

22. The method of claim 14, wherein the first carrier member and the second carrier member are substantially identical.

23. The method of claim 14, wherein coupling the first carrier member to the second carrier member comprises inserting a pin of the first carrier member into a recess defined in the second carrier member.
